(19) United States
(12) Patent Application Publication
(10) Pub. No.: US 2019/0280308 A1
(43) Pub. Date: Sep. 12, 2019

(54) FUEL CELL WITH DYNAMIC RESPONSE CAPABILITY BASED ON ENERGY STORAGE ELECTRODES

(71) Applicants: John LEMMON, Kennewick, WA (US); Jinlai LI, Langfang, Hebei (CN); THE REGENTS OF THE UNIVERSITY OF CALIFORNIA, Oakland, CA (US); ENN SCIENCE AND TECHNOLOGY DEVELOPMENT CO., LTD., Langfang, Hebei (CN)

(72) Inventors: Jinlai LI, Langfang, Hebei (CN); John LEMMON, Kennewick, WA (US); Yunfeng LU, Los Angeles, CA (US); Gurong SHEN, Los Angeles, CA (US); Jing LIU, Los Angeles, CA (US); Fang LIU, Los Angeles, CA (US); Haobin WU, Los Angeles, CA (US)

(21) Appl. No.: 16/345,643

(22) PCT Filed: Oct. 27, 2017
(86) PCT No.: PCT/US17/58826

§ 371 Date: Apr. 26, 2019

Related U.S. Application Data
(60) Provisional application No. 62/413,851, filed on Oct. 27, 2016.

(51) Int. Cl. H01M 4/90; H01M 4/88

(52) U.S. Cl. CPC H01M 4/9016; H01M 2004/8684; H01M 4/9083; H01M 4/8807

(57) ABSTRACT

A fuel cell includes: 1) an anode; 2) a cathode; and 3) an ion conducting membrane disposed between the anode and the cathode, wherein the anode includes a tungsten oxide-containing layer.

### CROSS-REFERENCE TO RELATED APPLICATION

This application claims the benefit of U.S. Provisional Application No. 62/413,851, filed Oct. 27, 2016, the content of which is incorporated herein by reference in its entirety.

### TECHNICAL FIELD

This disclosure generally relates to fuel cells incorporating an energy storage material.

### BACKGROUND

Fuel cell is one of the most promising technologies for the next-generation power supply in automotive vehicles, among other applications. Compared with other alternatives to power vehicles, such as lithium-ion batteries, fuel cell offers higher energy density and less pollution during fabrication, operation and recycle. Current fuel cell technologies, however, are constrained by cost and life time, as well as the poor response to fluctuations associated with operation conditions, fuel supply, and transient load. For automobiles using fuel cell as the power system, hybrid strategies have been built to achieve high fuel efficiency and high power output. Typically, batteries or capacitors are integrated with the fuel cell. The energy storage components would supplement the fuel cell when the power demand exceeded the power delivered by the fuel cell. However, the design of the energy management program for the hybrid electric system is complicated due to the complexity of the hybrid system. Moreover, the energy storage components occupy space in the vehicles and increase the cost as well.

It is against this background that a need arose to develop the embodiments described herein.

### SUMMARY

In some embodiments, a fuel cell includes: 1) an anode (or a negative electrode); 2) a cathode (or a positive electrode); and 3) an ion conducting membrane disposed between the anode and the cathode, wherein the anode includes a tungsten oxide-containing layer.

In some embodiments, the tungsten oxide-containing layer includes tungsten trioxide.

In some embodiments, the tungsten trioxide has a hexagonal crystalline structure.

In some embodiments, a loading of the tungsten trioxide in the anode is in a range of about 0.5 mg cm⁻² to about 30 mg cm⁻², about 0.5 mg cm⁻² to about 25 mg cm⁻², about 0.5 mg cm⁻² to about 20 mg cm⁻², about 0.5 mg cm⁻² to about 15 mg cm⁻², about 0.5 mg cm⁻² to about 10 mg cm⁻², about 1 mg cm⁻² to about 9 mg cm⁻², about 1 mg cm⁻² to about 8 mg cm⁻², about 1 mg cm⁻² to about 7 mg cm⁻², about 2 mg cm⁻² to about 7 mg cm⁻², about 3 mg cm⁻² to about 6 mg cm⁻², or about 4 mg cm⁻² to about 5 mg cm⁻².

In some embodiments, the tungsten trioxide is in the form of nanostructures, such as having at least one dimension in a range of about 1 nm to about 1000 nm, about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 200 nm, or about 1 nm to about 100 nm. The nanostructures can have aspect ratios of about 3 or less, or greater than about 3, such as about 4 or greater, about 5 or greater, or about 6 or greater. The nanostructures can be dispersed with a carbon-containing or carbonaceous material, such as carbon black or carbon nanotubes, to yield a tungsten trioxide/carbon composite. In some embodiments, the tungsten oxide-containing layer includes a tungsten trioxide/carbon composite including a carbonaceous material and the tungsten trioxide dispersed with the carbonaceous material. In some embodiments, a weight percentage of the tungsten trioxide in the composite is in a range of about 1% to about 99%, about 10% to about 99%, about 20% to about 99%, about 30% to about 99%, about 40% to about 99%, about 50% to about 99%, about 60% to about 99%, about 70% to about 99%, or about 70% to about 90%.

In some embodiments, the anode further includes an anode catalyst layer adjacent to the tungsten oxide-containing layer. In some embodiments, the anode catalyst layer includes platinum, another platinum group metal, or other electrocatalyst.

In some embodiments, the anode further includes an anode gas diffusion layer adjacent to the tungsten oxide-containing layer.

In some embodiments, the cathode includes a cathode catalyst layer. In some embodiments, the cathode catalyst layer includes platinum, another platinum group metal, or other electrocatalyst.

In some embodiments, the cathode further includes a cathode gas diffusion layer adjacent to the cathode catalyst layer.

In some embodiments, the ion conducting membrane is a proton exchange membrane.

In some embodiments, the proton exchange membrane is an acidic proton exchange membrane.

In some embodiments, the proton exchange membrane is a perfluorosulfonic acid membrane.

In some embodiments, the proton exchange membrane is a polybenzimidazole membrane doped with an acid. In some embodiments, the acid is phosphoric acid.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawing.

FIG. 1. (a) Schematic of a membrane electrode assembly (MEA) of a hybrid proton exchange membrane fuel cell (PEMFC) including a WO₃-based multifunctional anode, and (b) an equivalent circuit of the hybrid fuel cell.

FIG. 2. (a) X-ray diffraction (XRD) patterns and (b) thermogravimetric analysis (TGA) profiles of as-prepared WO₃/carbon nanotube (CNT) composites.

FIG. 3. (a, b) Transmission electron microscopy (TEM) images, (c, d) scanning electron microscopy (SEM) images, and (e) energy-dispersive X-ray spectroscopy (EDS) mapping of as-prepared WO₃/CNT composites.

FIG. 4. Schematic illustration of the structure and operating principle of (a) charging process and (b) discharging process for a rechargeable WO₃—O₂ supercapacitor.

FIG. 5. Fabrication process of MEA for a WO₃—O₂ supercapacitor.

FIG. 6. Galvanostatic discharging curves of WO₃—O₂ supercapacitor based on a WO₃—CP electrode (charged to about −0.3V vs. dynamic hydrogen electrode (DHE)) at different current densities.

FIG. 7. Galvanostatic discharge curves of WO₃—O₂ supercapacitors formed from (a, d) about 70% WO₃/CNT composite, (b, e) about 80% WO₃/CNT composite and (c, f) about 90% WO₃/CNT composite. The supercapacitors were charged to about −0.3 V prior to discharging.

FIG. 8. Galvanostatic discharge curves of WO₃—O₂ supercapacitors formed from (a, d) about 70% WO₃/CNT composite, (b, e) about 80% WO₃/CNT composite and (c, f) about 90% WO₃/CNT composite. The supercapacitors were charged to 0 V prior to discharging.

FIG. 9. Ragone plots of WO₃—O₂ supercapacitors with different WO₃/CNT composites.

FIG. 10. Fabrication process of MEA for a PEMFC.

FIG. 11. Influence of temperature on the performance of (a) control PEMFC and hybrid PEMFCs with different WO₃ loadings of (b) about 4.8 mg cm⁻², (c) about 14.3 mg cm⁻² and (d) about 21.1 mg cm⁻². The anode was fed with H₂ at about 100 mL min⁻¹. The cathode was supplied with O₂ at about 100 mL⁻¹.

FIG. 12. Influence of WO₃ loadings on the performance of hybrid PEMFCs at operating temperatures of (a) about 30, (b) about 50 and (c) about 80° C. The anodes were fed with H₂ at about 100 mL min⁻¹. The cathode was supplied with O₂ at about 100 mL min⁻¹.

FIG. 13. Polarization curves and power density of a hybrid cell (with WO₃/CNT electrode) and a control cell (without WO₃/CNT electrode) at about 30 and about 50° C. About 100% humidified H₂ (stoichiometry=about 1.2) and O₂ (stoichiometry=about 4) were fed to the anodes and cathodes, respectively.

FIG. 14. (a, d) Voltage, (b, e) ΔP, and (c, f) average ΔP at a time scale of about 5 s, about 10 s, about 15 s, and about 20 s of a control cell and a hybrid cell (WO₃ loading of about 4.8 mg cm⁻²) upon switching the current output from about 0.05 A cm⁻² to different current outputs at about 30° C. and about 50° C.

FIG. 15. Voltage and power of fuel cells in response to step-change of current density of (a, b) about 100 mA cm⁻² per step and (c, d) about 200 mA cm⁻² per step at about 30° C.

FIG. 16. Time dependent changes of cell voltage during H₂ starvation experiment.

FIG. 17. Typical TEM images of anodic electrocatalysts from (a) a control cell and (b) a cell with a WO₃ layer after H₂ starvation tests.

FIG. 18. Change of I-V performance of (a) a control cell and (b) a hybrid cell before and after H₂ starvation tests.

FIG. 19. Change of I-V performance of (a) a control cell and (b) a cell with WO₃ layer before and after load cycling tests.

FIG. 20. (a) Time dependent changes of cell voltage after air injected into anode compartments at about 30° C. (b) Current profiles of a control cell and a hybrid cell operated under a substantially constant voltage of about 0.8 V in response to air injection into anode compartments.

FIG. 21. Change of I-V performance of (a) a control cell and (b) a cell with WO₃ layer before and after start-up tests.

FIG. 22. Retention of peak power density of cells after three accelerated stress tests. A hybrid cell underwent all three tests, while three control cells were used for different durability tests.

FIG. 23. Fabrication processes of MEAs for (a) a WO₃—O₂ supercapacitor and (b) a hybrid PEN/WC.

FIG. 24. Configurations of PEMFCs based on WO₃ electrode and polybenzimidazole (PBI) electrolyte.

FIG. 25. Galvanostatic discharging curves of PBI-based PEMFCs operating in a WO₃—O₂ supercapacitor mode at different current densities.

FIG. 26. Polarization curves of PBI-based PEMFCs formed with (a) Pt/C anode and (b) WO₃-based anode at different temperatures.

FIG. 27. Discharge profiles of MEAs (a) with WO₃ layer and (b) without WO₃ layer after interrupting H₂ supply and discharged under different current densities.

### DETAILED DESCRIPTION

Embodiments of this disclosure relate to use of tungsten oxide as a high-performance energy storage material in fuel cells. The incorporation of such energy storage material allows the fabrication of fuel cells with dynamic capability in response to fluctuations during practical operation, reduces fabrication cost and increases lifetime.

Fuel cells with their high energy efficiency, high power density, and low emissions have been considered as desired power sources. The major constraints of current fuel cell technologies include the high cost, insufficient lifetime and the inadequate response to fluctuations associated with operation conditions, fuel supply and transient load. Integrating energy storage function in fuel cells can efficiently improve the dynamic response. Such improvement can also address the performance deterioration associated with frequently changing load during practical operation, and avoid the use of redundant size to compensate the poor dynamic response. Overall, incorporation of energy storage materials into electrodes of fuel cells can simultaneously address the challenges of fuel cells by improving the dynamic response to fluctuations and reducing the fabrication/application cost. Although energy storage materials, such as metal hydrides and manganese oxide, are incorporated into alkaline fuel cells to provide response function, such materials are incompatible with acidic proton exchange electrolytes (e.g., they dissolve or decompose in acidic electrolytes). Similarly, although V₂O₅ with high capacitance can be used as an energy storage material in fuel cells to afford a response function, vanadium oxides are unstable in acidic or basic electrolytes. Hydrated RuO₂ exhibits high capacitance, electron conductivity, proton conductivity and catalytic activity, and also chemically stable in acidic environment, but is cost-prohibitive. Inspired by proton channels in biological systems, an improved tungsten trioxide (WO₃) is developed that is compatible with acidic electrolytes, and also possesses excellent electron and proton conductivity, excellent energy storage capability, and excellent cycling stability.

Some embodiments are directed to fuel cells with significantly enhanced transient performance and prolonged lifetime by integrating electrodes (e.g., anodes) with a thin layer of tungsten oxide (WO₃). WO₃ electrodes can be incorporated into a membrane electrode assembly (MEA) of several types of fuel cells, including proton exchange membrane fuel cells (PENIFCs) based on either a perfluorosulfonic acid (Nafion®) or polybenzimidazole (PBI) membrane, solid acid fuel cells (SAFCs) and solid oxide fuel cells (SOFCs). This disclosure covers a broad range of fuel cell applications such as automotive vehicles and distributed power generation, among others. Embodiments are desirable for the high performance of fuel cells at fluctuating and high current outputs, and demonstrate a highly effective yet low-cost approach towards fuel cells with significantly improved power responsive capability. The hybrid PENIFCs with dynamic response capability are especially important for automobile applications, where frequent acceleration occurs and the cost is sensitive. Through integrating high-performance supercapacitors with PENIFCs, fuel cells are realized with enhanced power performance while simultaneously reducing the size and cost.

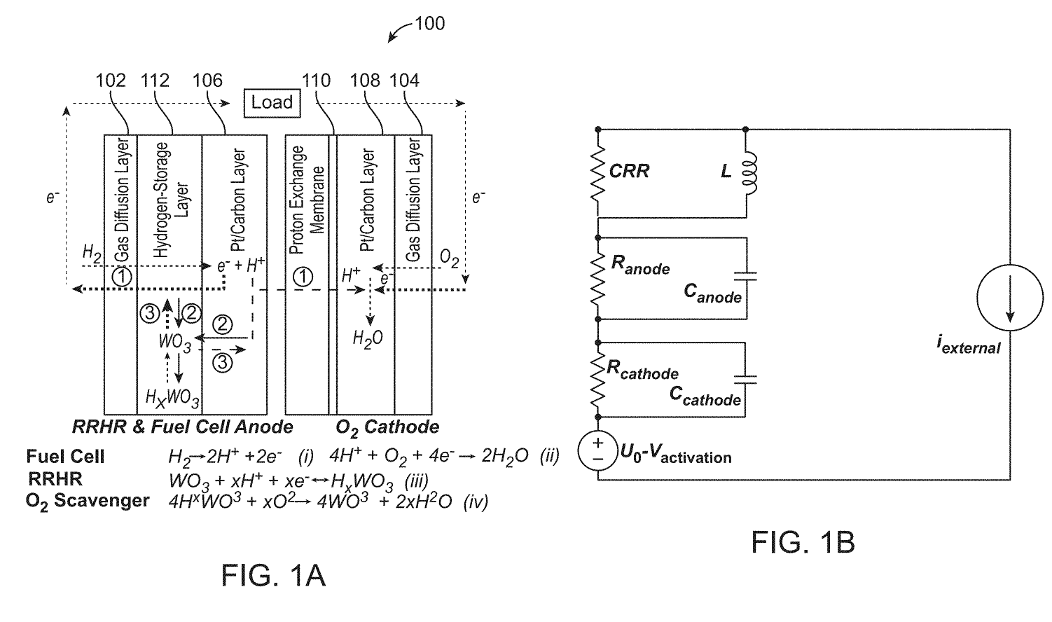

FIG. 1a illustrates a hybrid fuel cell 100 of some embodiments, which includes a MEA that includes a pair of gas diffusion layers (GDLs) 102 and 104, a pair of catalyst layers 106 and 108 (e.g., platinum loaded on carbon support (Pt/carbon) layers), and an ion conducting membrane 110 (e.g., a proton exchange membrane). The membrane 110 is disposed between the catalyst layers 106 and 108, which, in turn, are disposed between the GDLs 102 and 104. Although not shown, a pair of flow plates can be included one adjacent to the GDL 102, and another adjacent to the GDL 104. In the anode side, a layer of WO₃ 112 with a hexagonal crystalline structure is integrated so as to be disposed between the GDL 102 and the catalyst layer 106. Hexagonal WO₃ is a highly stable proton-electron mixed conductor, of which a high capacity of protons can be stored in a highly reversible and rapid manner at about −0.4 V to about 0.6 V vs. reversible hydrogen electrode in an acidic environment. The fuel cell 100 operates through the reaction (i) (H₂→2H⁺+2e⁻) and reaction (ii) (4H⁺+O₂+4e⁻→2H₂O) shown in FIG. 1a, where electrons and protons undergo the pathway 1. The WO₃ layer 112 serves as a rapid-response hydrogen reservoir (RRHR) by storing and releasing electrons and protons based on the reaction (iii) (WO₃+xH⁺+xe⁻↔HₓWO₃) through pathways 2 and 3, respectively. The WO₃ layer 112 also serves as a scavenger for any oxygen reaching the anode side through the reaction (iv) (4HₓWO₃+xO₂→4WO₃+2xH₂O) and a regulator for the hydrogen disassociation reaction (i). The equivalent circuit of the hybrid fuel cell 100 is shown in FIG. 1b, in which a voltage source is represented by U₀-V_{act}, where U₀ is cell voltage and V_{act} is activation polarization. The anode and cathode are represented by a parallel unit of a resistor R and a capacitor C, where R is the resistor for the ohmic loss and C is the capacitor due to double-layer charging effect. A parallel connection of a current-responsive resistor (CRR) and an inductor L is used to reflect the transient polarization that causes the power output delay during transient operation.

1. Synthesis of Materials and Fabrication of WO₃ Electrodes:

1.1 Synthesis of WO₃ Nanostructures and WO₃/Carbon Composites

WO₃ nanostructures: WO₃ was synthesized through a hydrothermal method using NH₄⁺ as a templating agent. For an example case, about 4.2 g of Na₂WO₄.2H₂O and about 1.65 g of (NH₄)₂SO₄ were dissolved in about 50 mL of deionized (DI) water. Then about 3 M H₂SO₄ was added into the solution dropwise under stirring to adjust the pH value of solution to about 1.5. Then the precursor solution was placed in an about 100 ml Teflon autoclave and underwent hydrothermal process at about 180° C. for about 24 h. The resulting WO₃ nanostructures were washed and dried for further use.

WO₃/carbon composites: WO₃/carbon composites were synthesized through an one-pot hydrothermal process using aqueous precursor solution for WO₃ in the presence of different carbonaceous materials, such as carbon black (XC-72) and carbon nanotubes (CNTs). Designed amount of Na₂WO₄.2H₂O and (NH₄)₂SO₄ were dissolved in about 50 mL of DI water, and about 3 M H₂SO₄ was added to adjust the pH value to about 1.5. Carbon material was then dispersed in the solution by sonication to achieve a desired weight ratio of carbon to WO₃. The solution was then transferred to an about 100 ml Teflon autoclave and reacted at about 180° C. for about 12 h. The resulting WO₃/CNT composites were washed and dried for further use. The composite is denoted as X WO₃/CNT, where X is the nominal weight content of WO₃.

1.2 Fabrication of WO₃ Electrodes

The WO₃ electrode can be fabricated using either carbon paper (CP) or carbon cloth (CC) as a current collector.

WO₃—CP and WO₃/CNT-CP electrodes: The WO₃ and carbon black (XC-72) were assembled onto CP (Toray TGH-060) as a current collector. Briefly, about 80 wt. % of the WO₃, about 10 wt. % of carbon black, and about 10 wt. % of perfluorosulfonic acid (Nafion®) dispersed in ethanol were mixed to form slurries. The homogenous slurries were sprayed on the CP. The fabrication of the WO₃/CNT-CP electrode follows the same procedure of the WO₃—CP electrode.

WO₃/CNT-CC electrode: CC was treated with polytetrafluoroethylene (PTFE) to increase its hydrophobicity. After a desired PTFE content is achieved, the PTFE-impregnated CC was sintered at about 340° C. in N₂ for about 30 min. A micro-porous layer formed of carbon black (XC-72) and PTFE was then coated on the PTFE-treated CC. After that, an ink of WO₃/CNT was sprayed on the above substrate. The electrode was applied under a pressure of about 50 MPa for about 2 min before assembled into a MEA.

1.3 Physical Characterizations

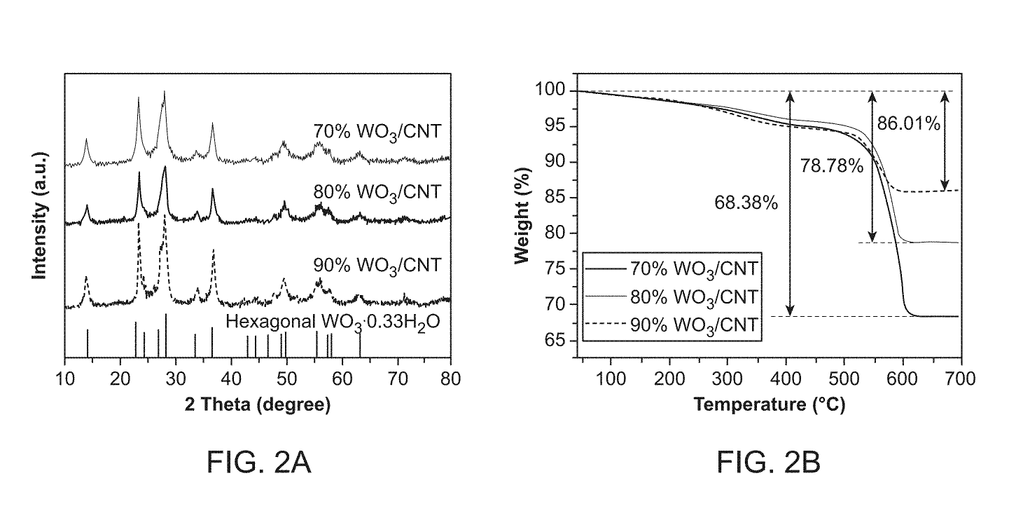

FIG. 2a shows X-ray diffraction (XRD) patterns of as-prepared WO₃/CNT composites. The WO₃ in all samples exhibits substantially the same hexagonal structure. FIG. 2b displays thermogravimetric analysis (TGA) profiles of the samples in air. The weight loss below about 400° C. is mainly due to the removal of H₂O within crystalline channels of WO₃. After the temperature was increased to about 600° C., the carbon moieties were burned off and just the WO₃ was left. The weight losses of about 70% WO₃/CNT, about 80% WO₃/CNT and about 90% WO₃/CNT composites are about 33.04%, about 22.52% and about 15.53%, respectively. Accordingly, the weight percentages of the WO₃ in the composites are about 67.0%, about 77.5% and about 84.5%, respectively.

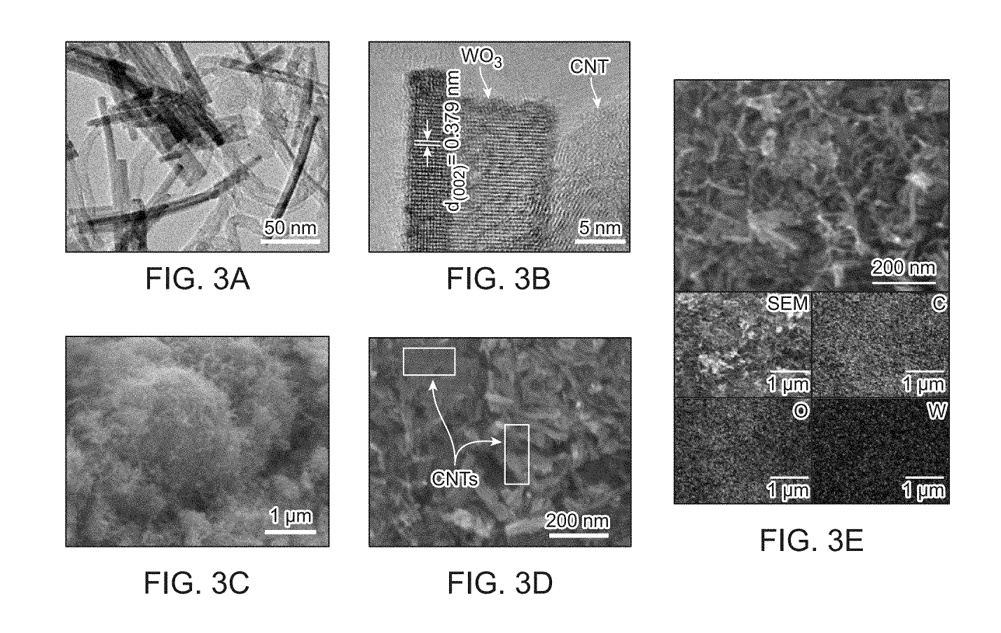

Transmission electron microscopy (TEM) image in FIG. 3a shows the detailed structure of the composite. WO₃ nanorods are about 5 nm to about 10 nm in diameter and about 60 nm to about 100 nm in length, intertwining with CNTs of about 20 nm in diameter and up to several micrometers in length. High-resolution TEM image (FIG. 3b) displays a WO₃ nanorod with (002) lattice planes, which is intimately contacted with a multi-wall CNT. FIG. 3c shows a representative scanning electron microscopy (SEM) image of the WO₃/CNT composite, exhibiting a micrometer-sized particulate morphology. The magnified SEM image in FIG. 3d reveals that particles are formed by entangled networks of WO₃ nanorods and CNTs. As shown in energy-dispersive X-ray spectroscopy (EDS) mapping images (FIG. 3e) of C, O and W elements, the distribution of the W moiety is consistent with that of the C and O moieties, indicating a substantially uniform distribution of WO₃ and CNTs within the composite. Such composite structure can provide substantially continuous conductive pathways, leading to excellent energy storage capability.

2. Demonstration of WO₃—O₂ Supercapacitor:

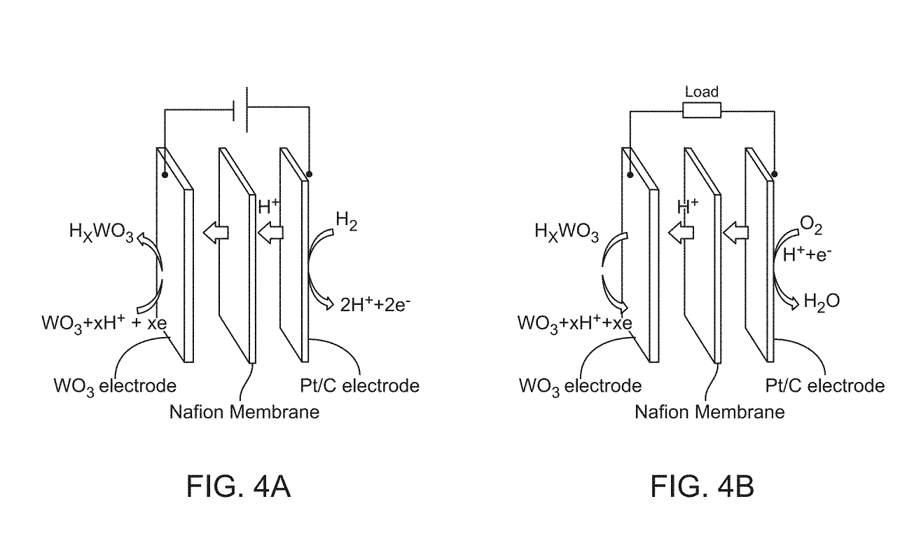

FIG. 4 schematically presents the structure and operation principle of a rechargeable WO₃—O₂ supercapacitor. Charging of the WO₃—O₂ supercapacitor is performed by feeding hydrogen into a Pt/C electrode. The hydrogen is oxidized on the Pt/C electrode, working as a dynamic hydrogen electrode (DHE). Proton released from the hydrogen is transferred toward and stored in a WO₃ electrode. WO₃—O₂ supercapacitor is discharged when supplying oxygen to the Pt/C electrode. The charged WO₃ electrode will be oxidized and release protons and electrons. The electrons pass through an electrical circuit to the Pt/C electrode. Combining with the protons and electrons, oxygen is reduced to water on the Pt/C electrode.

2.1 MEA Fabrication for WO₃—O₂ Supercapacitor

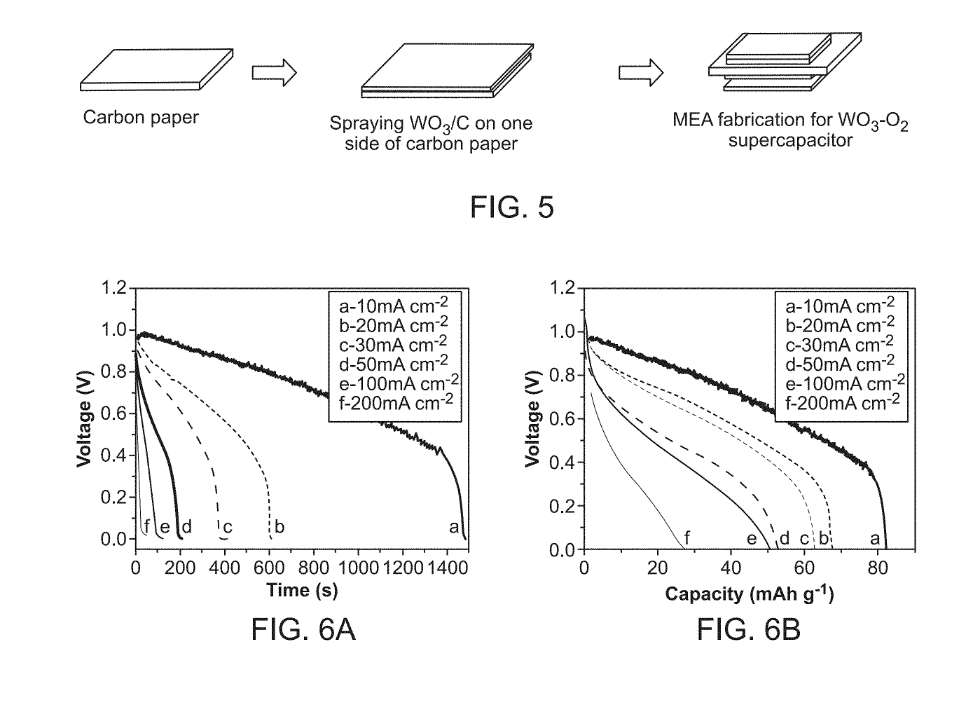

As illustrated in FIG. 5, perfluorosulfonic acid (Nafion® 212) membranes were used as ion conducting layers. To prepare a catalyst layer of the cathode, a homogeneous ink was prepared using commercial Pt/C (about 40 wt. % Pt, JM) and perfluorosulfonic acid solution in ethanol. The ink was deposited on the membrane by a spraying procedure. The Pt loading in the cathode was about 0.4 mg cm⁻² for all MEAs. The MEAs were made by sandwiching catalyst coated membrane between a WO₃ electrode and a GDL with catalyst facing the GDL, and then applying a pressure of about 20 MPa for about 2 min at about 135° C.

2.2. Performance of WO₃-Air Supercapacitor

To explore the energy storage capability of the WO₃ electrodes, the electrodes were first charged to a constant potential and then discharged at different rates. Here, the terminal charging potential of about −0.3 V (vs. dynamic hydrogen electrode (DHE)) and 0 V (vs. DHE) was investigated. FIG. 6 shows the galvanostatic discharging curves of the WO₃—O₂ supercapacitor based on a WO₃—CP electrode pre-charged to about −0.3 V vs. DHE. The open circuit voltage is about 1.23 V, which is about 300 mV lower than the theoretically expected value of about 1.53 V. This is mainly caused by the mixed potential of Pt/PtO on the catalyst surface. The voltage decreases with the consuming of the active material under different discharge current densities. The working durations of the WO₃—O₂ supercapacitor to supply electrical energy at different discharge current densities are summarized in Table 1. It can be seen that this device is able to supply electrical energy for about 1473 s at a discharge current density of about 10 mA cm⁻². Even when the output current density increases to about 200 mA cm⁻², the output can last for about 21 s. In contrast, the WO₃ electrode based on the physical mixture of WO₃ and carbon black shows relatively poor rate capability. For example, at a relatively low current density of about 10 mA cm⁻², such WO₃ electrode can deliver a discharge capacity of about 83 mAh g⁻¹, which is close to the theoretical capacity of WO₃ (about 110 mAh g⁻¹), while the capacity was about 20 mAh g⁻¹ at a current density of about 200 mA cm⁻². This may be due to the inefficient electron and ion transport, as well as the low utility of the active material in the thick electrode. (The thickness of an electrode with about 0.48 g of WO₃ is about 370 μm, and GDL is about 240 μm in thickness).

TABLE 1
Summary of working durations of WO₃—O₂ supercapacitor
at different discharge current densities.

Current Density (mA cm⁻²)

| | a | b | c | d | e | f |
|---|---|---|---|---|---|---|
| | 10 | 20 | 30 | 50 | 100 | 200 |
| Time (s) | 1473 | 605 | 374 | 189 | 89 | 21 |

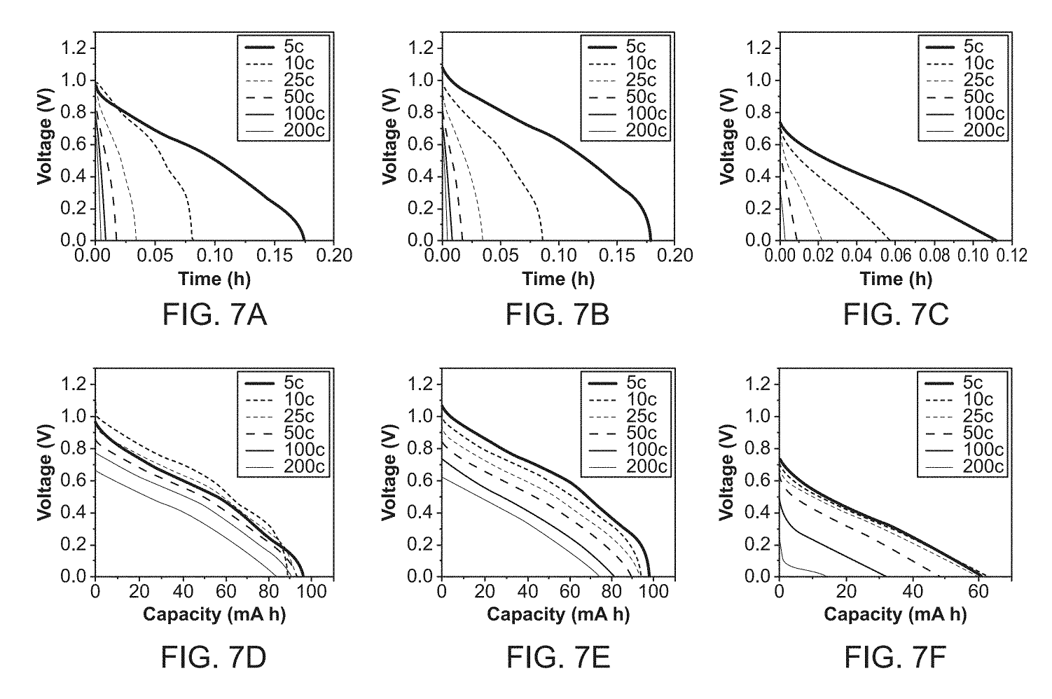

The above result indicates the feasibility of integrating a WO₃ electrode in an anode of a PEMFC as an energy storage component. To further enhance the performance of the WO₃—O₂ supercapacitor, WO₃ nanorod intertwined with conductive CNT network was applied as the active material to fabricate the electrode. FIG. 7 shows the galvanostatic discharging curves of WO₃—O₂ supercapacitors at different discharging rates. Prior to the discharging, the supercapacitors were charged to about −0.3 V (vs. DHE) using a constant current of about 100 mA. The charging process was conducted by supplying the Pt/C cathode with hydrogen (about 0.1 L min⁻¹) and the WO₃ anode with nitrogen (about 0.1 L min⁻¹). The supercapacitors exhibit a typical capacitive discharging behavior, showing nearly linear decrease of the voltage with discharging time. The supercapacitor fabricated with about 90% WO₃/CNT exhibits relatively poor rate performance due to low electric conductivity. With increasing content of CNT in the composite, the supercapacitor formed from about 80% WO₃/CNT exhibits improved rate performance, which delivers a specific capacity of about 80 mAh g¹ at a discharging rate of about 200 C. However, since CNT provides much less capacity than WO₃, further increasing the content of CNT may not benefit the overall performance of WO₃/CNT electrode. The desired weight ratio of WO₃ in the composite is determined to be about 80% in some embodiments.

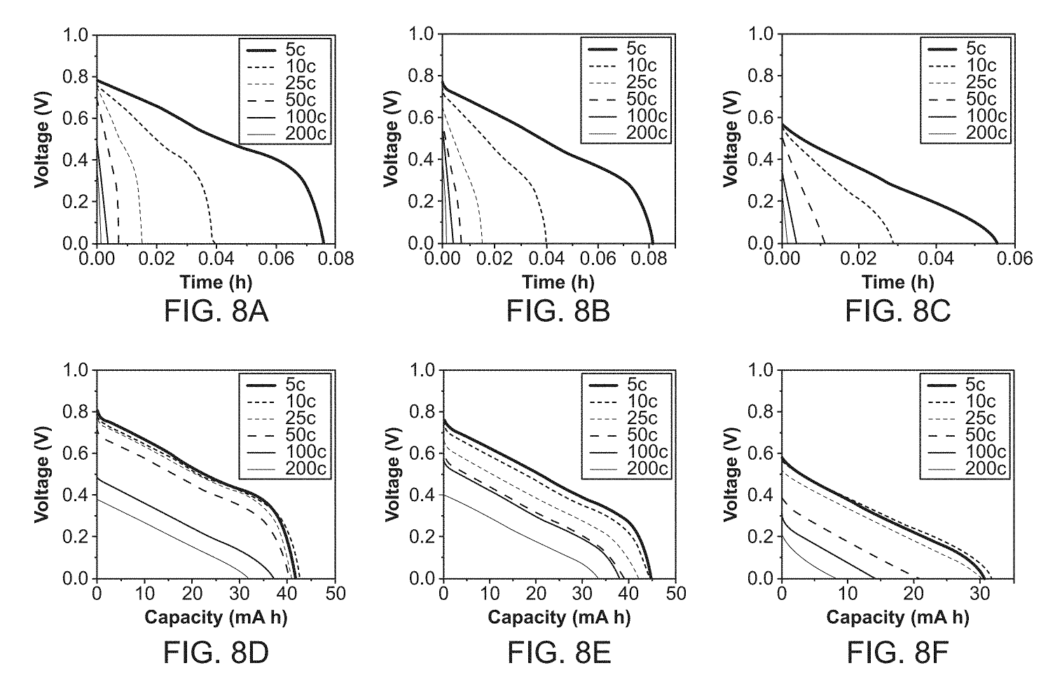

The electrocatalytic ability of WO₃ for hydrogen oxidation can be poor at low temperature; therefore, a catalyst layer composed of Pt/C is included to promote hydrogen oxidation in an anode of a hybrid PEMFC. With the presence of platinum, the hydrogen evolution reaction occurs on a WO₃ electrode with a small overpotential. In this case, the WO₃—CP electrode is charged to 0 V vs. DHE and the corresponding discharging behavior was investigated. To further evaluate the performance of WO₃—O₂ supercapacitors under the operating condition of the PEMFC (e.g., anode potential of 0 V), the WO₃—O₂ supercapacitors were also pre-charged to 0 V (vs. DHE), and the galvanostatic discharging curves are shown in FIG. 8. The optimized supercapacitor can still deliver a specific capacity between about 33 to about 45 mAh g¹.

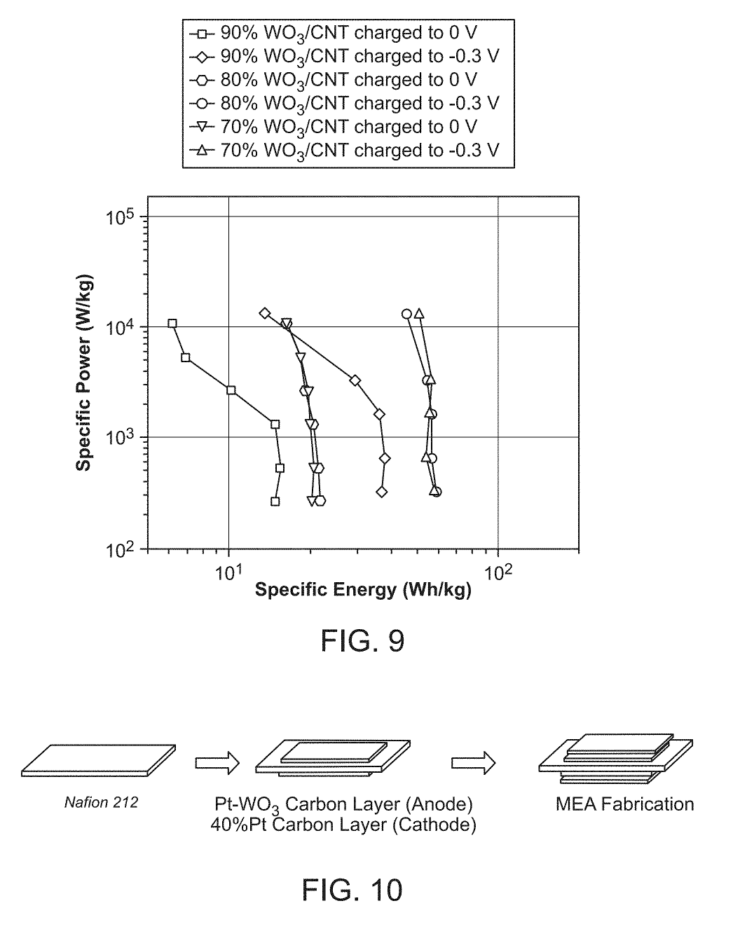

To further quantify the performance of the WO₃—O₂ supercapacitors, Ragone plots of the supercapacitors are provided in FIG. 9. As shown, supercapacitors fabricated with about 80% WO₃/CNT and about 70% WO₃/CNT samples (charged to about −0.3 V) possess similar performance, with energy densities between about 45 to about 58 Wh kg⁻¹ and power density up to about 13 kW kg⁻¹.

3. Demonstration of Energy Storage Function of WO₃-Integrated PEMFC (Perfluorosulfonic Acid Electrolyte):

3.1. MEA Fabrication for PEMFC

MEAs for a PEMFC were formed using a procedure similar to that of the WO₃-air supercapacitor as shown in FIG. 10. Briefly, Pt/C was coated on both sides of a perfluorosulfonic acid membrane. The Pt loadings of an anode and a cathode are about 0.05 mg cm⁻² and about 0.4 mg cm⁻², respectively. MEAs with an active area of about 5 cm² were fabricated by sandwiching the catalyst-coated membrane between a WO₃ electrode and a GDL, and then hot pressed together. Control MEA sample was fabricated with GDL instead of a WO₃ electrode on the anode side.

Hybrid PEMFCs with different loadings of WO₃ were fabricated using the about 80% WO₃/CNT composite, and their performances were examined under different operating temperatures.

3.2. Performance of Hybrid PEMFCs

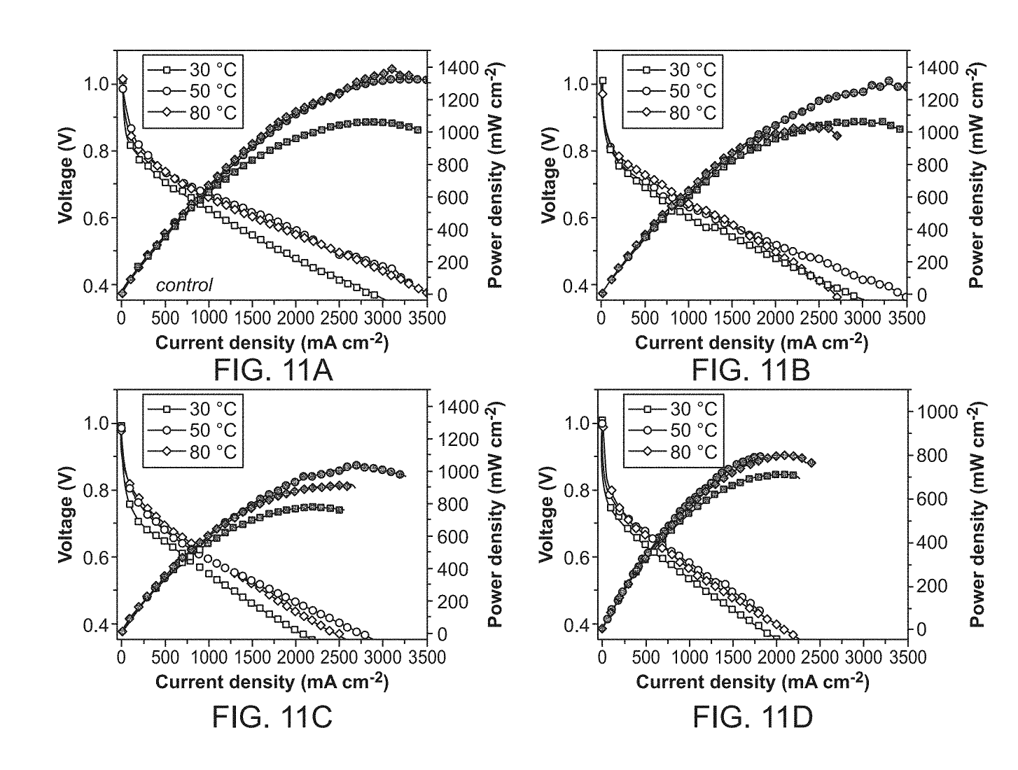

FIG. 11 shows the polarization curves of these devices at different operating temperatures. FIG. 11a shows the performance of a control cell, which is enhanced when temperature is increased from about 30° C. to about 50° C. The performance of the cell remains similar when the temperature is further increased to about 80° C. The hybrid PEMFCs show similar behavior when the temperature is increased from about 30° C. to about 50° C. With the temperature increased to about 80° C., the performance of the hybrid PEMFCs with WO₃ loadings of about 4.8 mg cm⁻² and about 14.3 mg cm⁻² drops when the discharging current density is higher than about 2500 mA cm⁻².

Operation temperature affects the reaction kinetics, proton conductivity, and gas diffusion of the devices. Increasing the temperature from about 30° C. to about 50° C. favors faster reaction kinetics, proton conduction and gas diffusion, which lead to improved device performance. Further increasing temperature to about 80° C. should increase the reaction kinetics and transport kinetics. However, it was found that the performance at about 80° C. is similar to that at about 50° C. This may be attributed to the reduced degree of saturation of the feeding gas, which retards the transport of protons. As a result, the performance of the device remains similar as that operated at about 50° C. For the hybrid devices, a similar trend was observed. The dropping performance observed at about 80° C. and at high discharge current density may be due to the decreased proton conductivity. This can be addressed by optimizing the structure of the WO₃ electrodes and humidified condition.

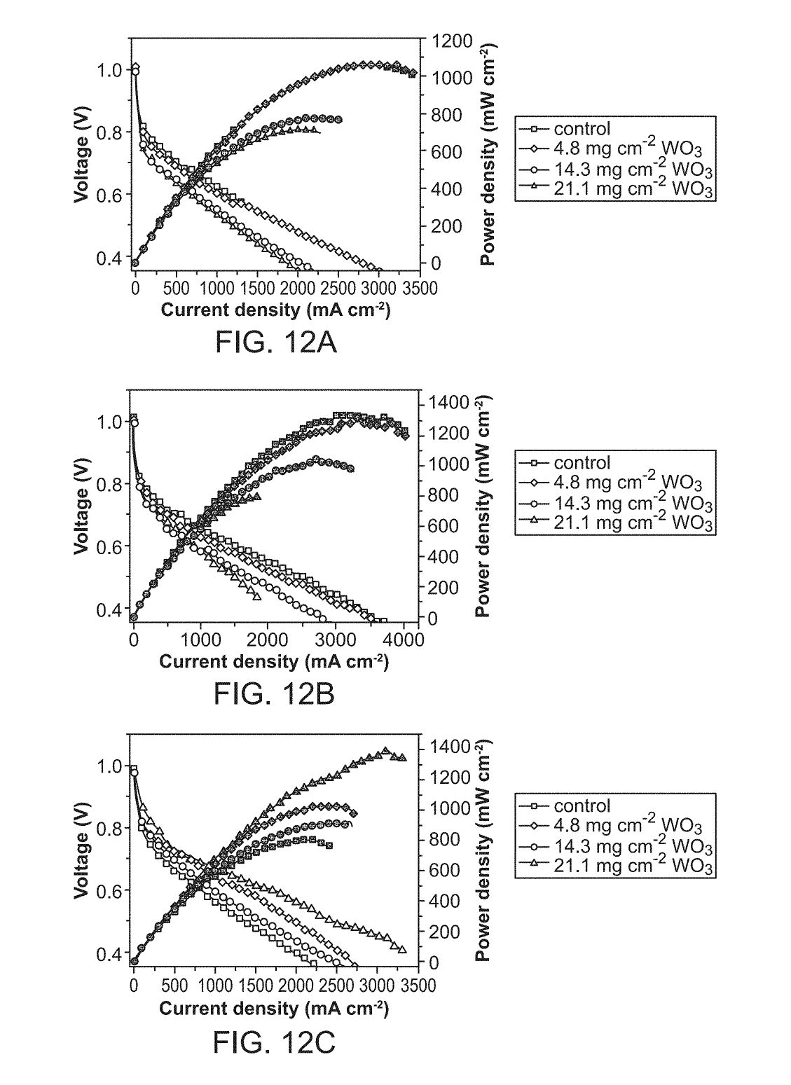

The polarization curves of hybrid PEMFCs with different WO₃ loadings at different operating temperatures are shown in FIG. 12. At about 30° C., the cell with about 4.8 mg cm⁻² of WO₃ loading shows similar performance with that of the control cell. With increasing WO₃ loadings, the corresponding peak power densities of the hybrid PEMFCs are about 1059, about 776 and about 715 mW cm⁻² for WO₃ loadings of about 4.8, about 14.3 and about 21.1 mg cm⁻², respectively. The hybrid PEMFC with a low WO₃ loading of about 4.8 mg cm⁻² can achieve performance comparable to the control cell (e.g., at about 30 and about 50° C.), which is possibly attributed to the small electrode thickness and series resistance compared with electrodes of higher WO₃ loadings. The cells exhibit improved power density with increasing temperature to about 50° C.; the effect of the WO₃ loading on the performance is similar as that at about 30° C.

3.3. Dynamic Response of the Hybrid PEMFCs

Comparative fuel cells can exhibit poor power performance despite their high energy density. For fuel cell vehicles, dynamic operations such as acceleration specify high power and rapid response; frequent operation at high power may deteriorate the lifetime and performance of fuel cells. Herein, it is demonstrated that PEMFCs can possess dynamic response capability through integrating WO₃ supercapacitors within the PEMFCs. The dependency of dynamic response capability on the loading of WO₃ in the hybrid PEMFCs has been identified.

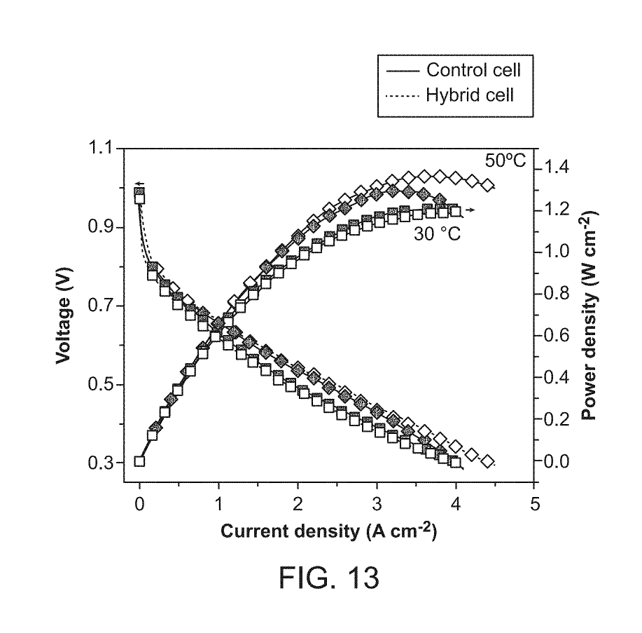

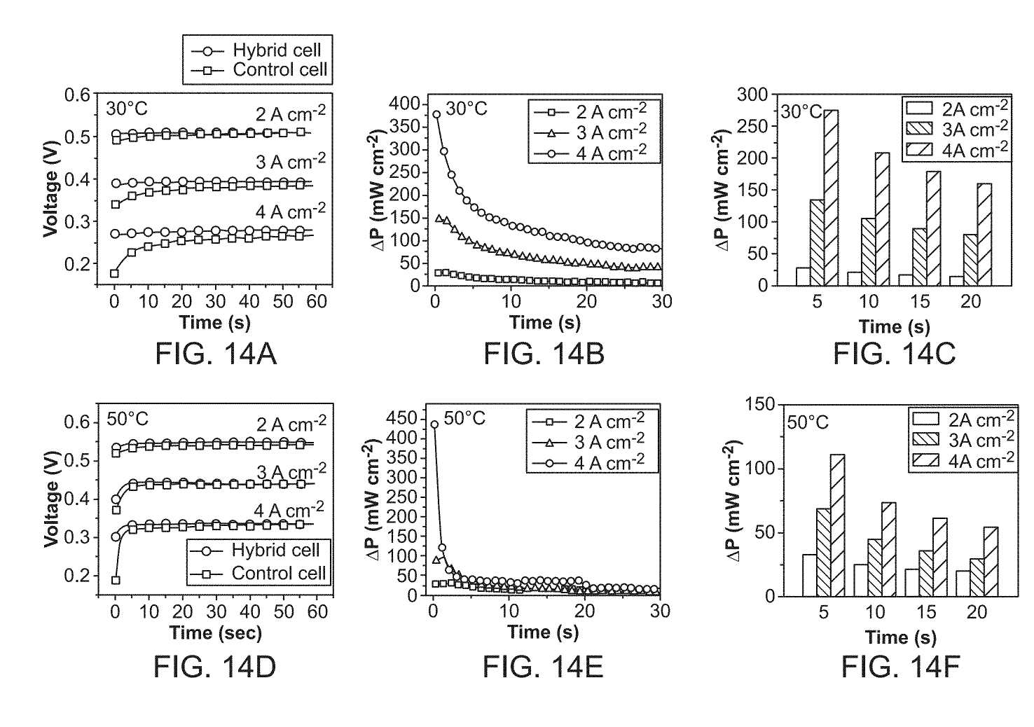

Fuel cells were then assembled to examine their transient performance. FIG. 13 shows the polarization curves of a hybrid cell (with WO₃ at a mass loading of about 5.1 mg cm⁻²) and a control cell (without WO₃) at about 30° C. and about 50° C., respectively. Both cells exhibit nearly overlapped polarization curves and a similar peak power density, indicating that incorporating a WO₃ layer does not significantly alter the transport characteristic of the cells. To compare their transient performance, the cells were operated under a current density of about 0.2 A cm⁻² and subjected to current outputs of about 2 A cm⁻², about 3 A cm⁻² and about 4 A cm⁻², respectively, during which the cells were returned to about 0.2 A cm⁻² after each increasing-current test. FIG. 14a shows their voltage-time profiles at about 30° C. For the control cell, voltage increases with time approach a steady voltage, indicating a power-output delay that becomes more pronounced with increasing current output. For example, a voltage undershoot of about 100 mV is observed with the current output of about 4 A cm⁻² (corresponding to about 100% of the maximum power output), which takes more than about 30 s to reach the steady voltage. In contrast, the hybrid cell shows much less delay, indicating improved power performance. Consistently, both cells exhibit higher voltages at about 50° C. due to improved reaction and transport kinetics, while the hybrid cell still shows significantly less voltage delay than the control cell (FIG. 14d).

FIG. 14b compares their power-output differences (ΔP), which are estimated by subtracting the power density of the control cell from that of the hybrid cell. Upon changing the current density from about 0.05 A cm⁻² to about 4 A cm⁻² at about 30° C., ΔP reaches about 378 mW cm⁻² at the beginning and decreases with time. The average ΔP within a transient period of about 5 s, about 10 s, about 15 s and about 20 s is about 276 mW cm⁻², about 210 mW cm⁻², about 179 mW cm⁻² and about 160 mW cm⁻², corresponding to about 23%, about 17.5%, about 15% and about 13% of the maximum power output, respectively (FIG. 14c). The energy-output difference (4E) is about 1.38 J cm⁻² and about 2.68 J cm⁻² for the first about 5 s and about 15 s transient periods, respectively. FIG. 14e shows the ΔP profiles at about 50° C., which are decayed more rapidly with time, which is consistent with the faster reaction and transport kinetics. As a result, the average ΔP within the same transient period is less than that of about 30° C.; nevertheless, ΔP at the transient period of about 5 s still corresponds to about 10% of the maximum power output (FIG. 14f).

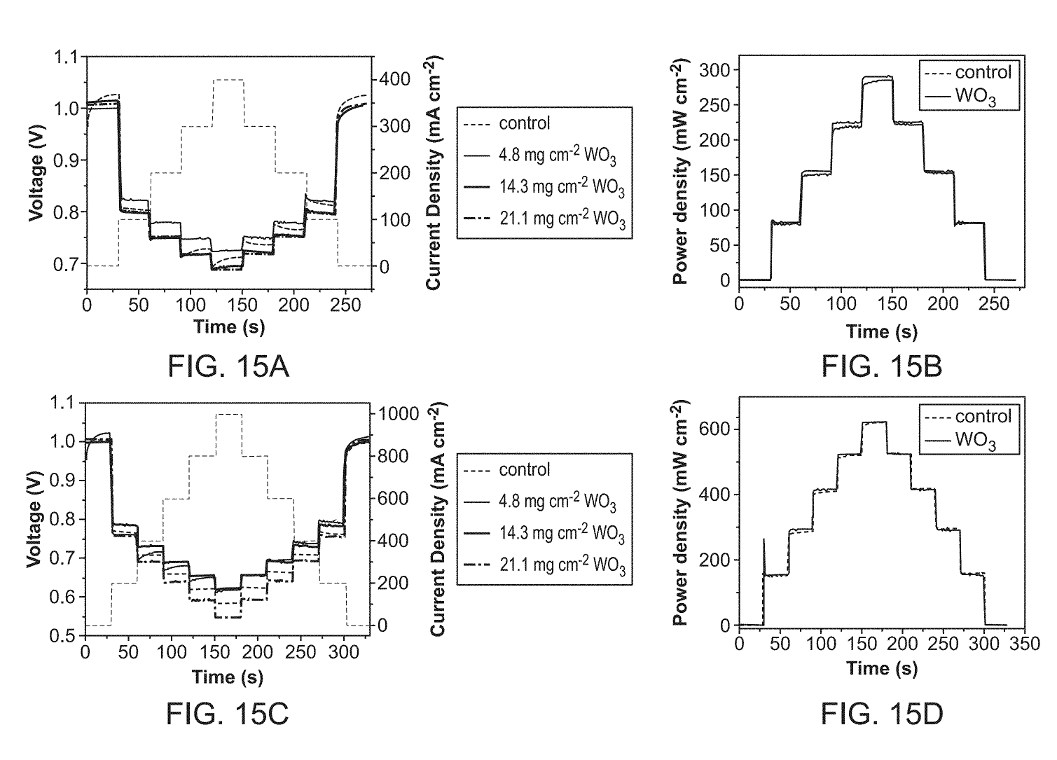

FIG. 15 compares the voltage of the cells in response to a step-change of current density of about 100 mA cm⁻² per step and about 200 mA cm⁻² per step at an operating temperature of about 30° C. When the current is increased by a step of about 100 mA cm⁻², similar transient behavior is observed. For the control cell, voltage drop of about 5-10 mV below the steady-state voltage is observed when increasing the current density to about 400 mA cm⁻². In contrast, the hybrid cell shows insignificant transition in voltage (<about 4 mV). These results indicate that integrating PEMFCs with WO₃ supercapacitors provides better power performance in response to increasing power demand at different rates, such as high power demand at startup and lower power demand at acceleration.

FIGS. 15b and 15d show the power of control cell and the hybrid PEMFC with WO₃ loading of about 4.8 mg cm⁻² in response to the current output. The hybrid PEMFC exhibits a higher power output than the control cell at step-increase current demand. Notably, the hybrid PEMFC with about 4.8 mg cm⁻² WO₃ outperforms the control cell in terms of the dynamic capability despite of a similar steady-state performance.

In summary, through optimizing the weight ratio of WO₃ and CNT as well as the mass loading of WO₃ in the electrode, the series resistance of the hybrid device is effectively reduced. The optimal hybrid PEMFCs of some embodiments exhibit performance comparable with those of PEMFCs at steady state, but provide better power performance in response to increasing power demand at different rates.

3.4 Improved Durability of Fuel Cell Against Harsh Operating Conditions

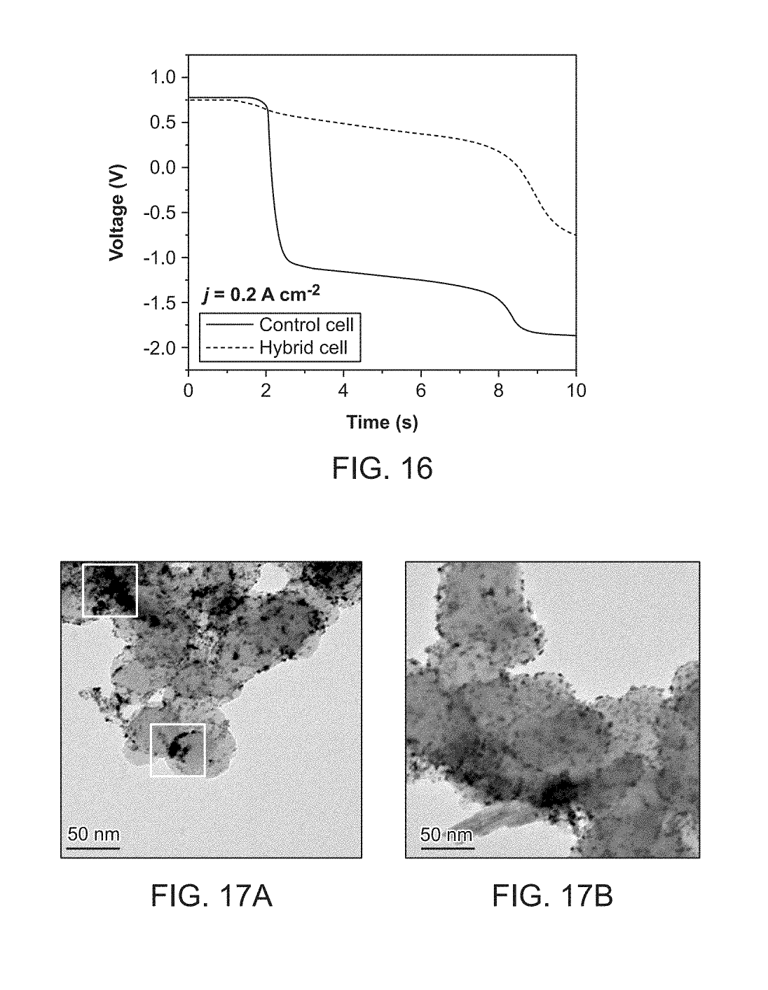

Beyond their improved transient performance, hybrid PEMFCs also exhibit dramatically improved durability against harsh operating conditions, such as fuel starvation, a main cause of degradation of PEMFCs. To demonstrate the improvement against fuel starvation, a hybrid cell and a control cell were operated under a substantially constant current density of about 0.2 A cm⁻², during which the feeding H₂ was switched to N₂ and cell voltage was recorded (FIG. 16). For the control cell, the voltage drops rapidly below about −1.0 V at about 2 s after the termination of hydrogen supply and continuously decreases with time. In comparison, the hybrid fuel cell shows much slower voltage decay; the occurrence of cell-voltage reversal is significantly delayed by about 6.5 s, indicating that the composite anode does improve durability against fuel starvation.

The observed cell-voltage reversal indicates that the anodic potential becomes more positive than the cathodic potential. Such a high anode voltage causes anode oxidation and catalyst aggregation, further deteriorating performance. Typical TEM images of the anodic catalyst samples from the two cells are displayed in FIG. 17. A severe aggregation of platinum nanoparticles is observed for the control cell, while the catalyst nanoparticles remained distributed uniformly on a carbon support of the cell with a WO₃ layer. The results indicate that the WO₃ layer functions as a buffer layer that can effectively alleviate the anodic polarization and protect the electrocatalyst from degradation.

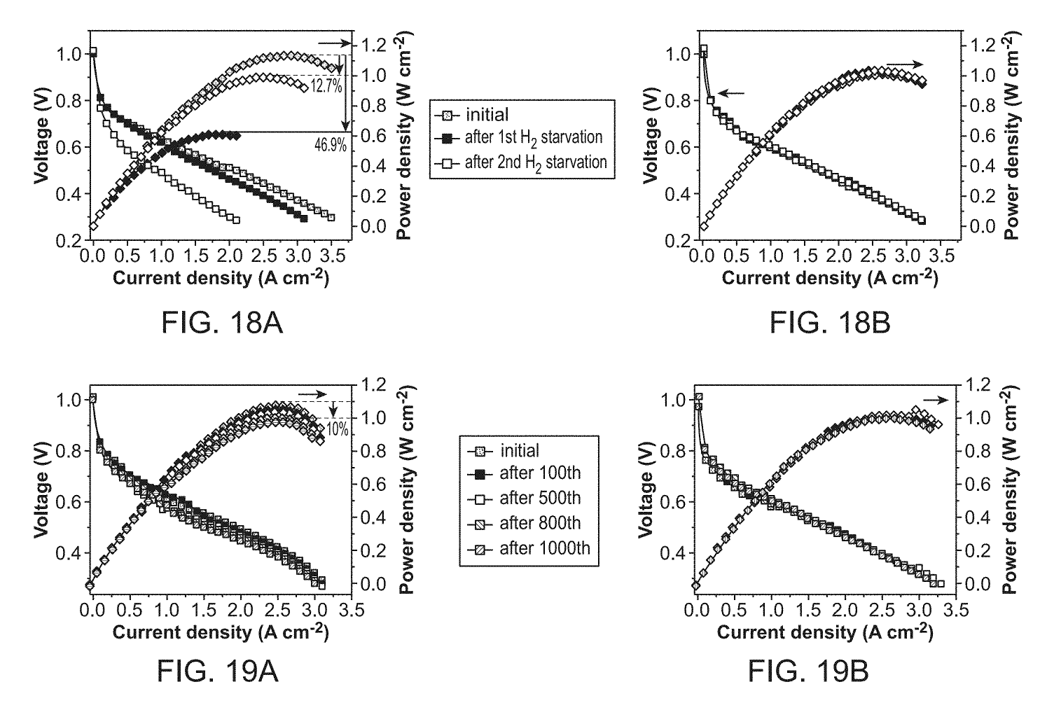

Consistently, as shown in FIG. 18a, the control fuel cell shows rapid peak-power decay, which is about 53% of the initial value after two rounds of fuel-starvation test. In contrast, the hybrid cell exhibits outstanding stability with almost no degradation of the performance as shown in FIG. 18b.

Fuel starvation also occurs during transient operations, such as an accelerating-deaccelerating process. To examine the improved durability against such transient operations, a control cell and a hybrid cell were subjected to oscillating current output between about 50 and about 1000 mA cm⁻² with a holding time of about 120 and about 30 s, respectively. The control cell exhibits a steady decrease in peak power by about 10% after 1000 testing cycles, in contrast to the unaltered performance of the hybrid cell, indicating improved durability against dynamic operating conditions (FIG. 19).

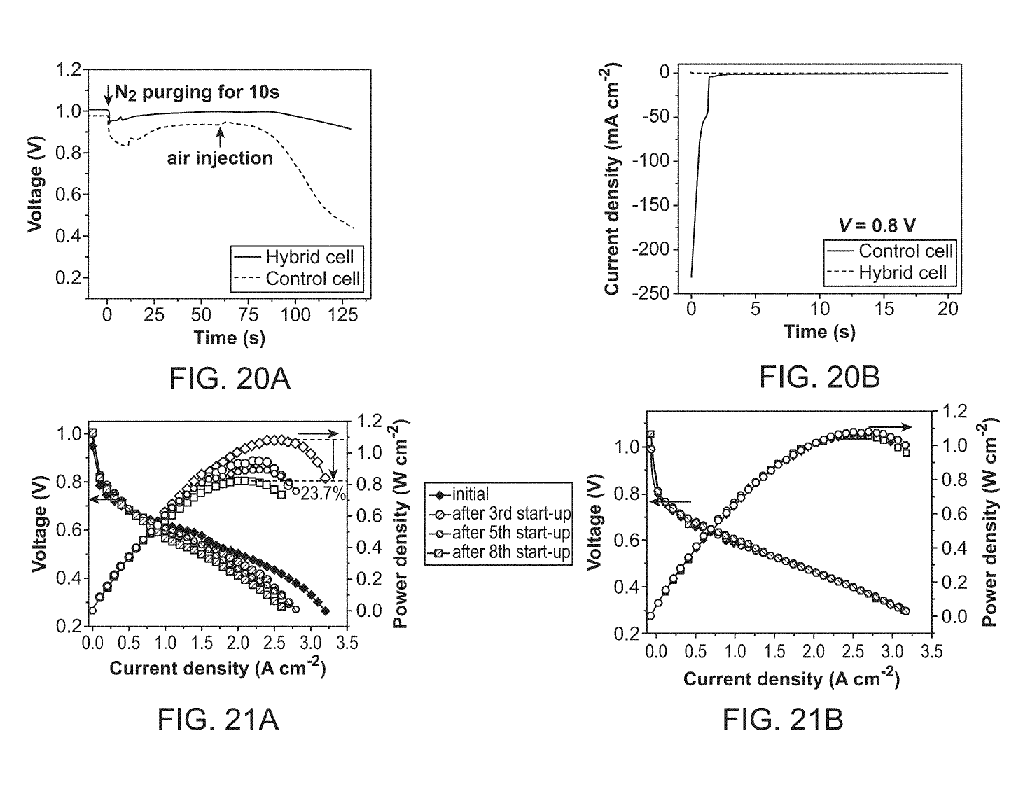

Another noticeable cause of fuel cell degradation is the start-up process, during which residual air in an anode increases anode potential, which results in a dramatic increase of cathode potential if operated under a normal cell voltage. The increased cathode potential can lead to cathode oxidation that deteriorates cell performance and lifetime. The integrated RRHR can scavenge oxygen effectively (reaction (iv)), stabilizing the anode and cathode potentials for the hybrid cell. To demonstrate this effect, a control cell and a hybrid cell were operated normally, during which the hydrogen flow was switched to nitrogen flow and about 1 mL of air was injected into the cells, respectively. The control cell shows a gradual drop of an open circuit voltage (OCV) from about 1.0 V to about 0.44 V, while the hybrid cell still retains an OCV of about 0.91 V after the air injection (FIG. 20a). FIG. 20b presents their current profiles upon being subjected to a substantially constant voltage of about 0.8 V. For the control cell, a large negative current over about −230 mA cm⁻² is observed, indicating occurrence of cathode oxidation.

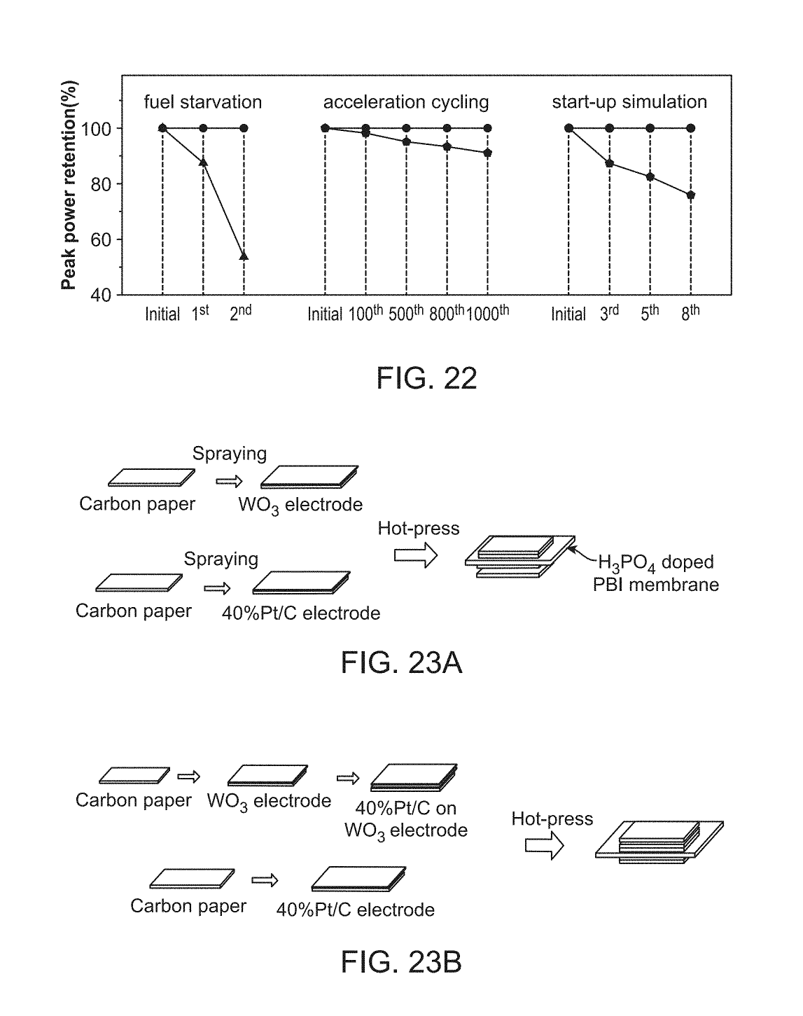

Consistently, the peak power of the control cell drops about 24% after eight cycles of start-up simulation test (FIG. 21a). For the hybrid cell, in sharp contrast, an initial discharging current of about 0.35 mA cm⁻² is observed. The discharging current decreases with time; however, no noticeable cathode oxidation current could be observed, indicating improved durability against oxygen invasion into anodes. Consistently, the hybrid cell shows negligible peak power degradation after the start-up test (FIG. 21b). The retention of peak power density of cells after three accelerated stress tests was recorded in FIG. 22. The hybrid cell shows superior stability and durability against various unsteady conditions.

In summary, through integrating WO₃-based RRHR within PEMFCs, high-performance WO₃—O₂ supercapacitors (“parasite”) can be formed by using electrolytes and cathodes of the fuel cells (“host”) as their electrolytes and cathodes. Such parasitism allows the fabrication of high-performance supercapacitors within PEMFCs with extremely low cost (mainly the cost of WO₃). More importantly, the WO₃ layer functions as a buffer layer that effectively alleviates the anodic polarization under harsh operating conditions and prolongs the lifetime of fuel cells. Such design can boost the development of PEMFCs for fuel cell vehicles by dramatically reducing the size of the fuel cells and cost as well as improving the durability.

4. Demonstration of WO₃-Loaded MEAs with PBI Electrolytes:

4.1 Fabrication of PBI-Based MEAs

WO₃ electrode: WO₃ and carbon black (XC-72) were assembled onto CP (Toray TGH-060) as a current collector. Briefly, about 80 wt. % of WO₃, about 10 wt. % of carbon black, and about 10 wt. % of polyvinylidene fluoride (PVDF) dispersed in ethanol were mixed to form a slurry, which was sprayed onto the CP.

Electrolyte: Phosphoric acid (PA) is used as a doping agent for PBI membrane due to its high conductivity. PBI membrane (fumapem AM cross-linked Fuma-Tech) was doped by immersing the membrane into about 85 wt. % PA at about 120° C. for about 6 h. The excess H₃PO₄ on the membrane surface was removed by wiping with a filter paper. The PBI membrane was weighed before and after the doping, which is denoted as W1 and W2, respectively. The doping level was then estimated by (W2−W1)/W1.

WO₃—O₂ supercapacitor: The fabrication a WO₃—O₂ supercapacitor is illustrated in FIG. 23a. A homogeneous ink was formed from Pt/C (about 40 wt. % Pt, JM) and PBI solution (using dimethylacetamide as a solvent), which was sprayed on a GDL to form a cathode. The Pt loading for the cathode was controlled at about 1 mg cm⁻². The supercapacitor was formed by sandwiching the PBI membrane between the cathode and the WO₃ electrode at about 0.25 MPa for about 3 min at about 140° C.

PEMFC: The fabrication of a MEA for a PEMFC with PBI electrolyte was conducted using a similar procedure, which is illustrated in FIG. 23b. Briefly, Pt/C was also coated on the WO₃ electrode. The cathode was fabricated using a similar procedure. The Pt loading was maintained at about 1 mg cm⁻² for both the anode and cathode. MEAs with an active area of about 9.61 cm² or about 4 cm² were fabricated by sandwiching the PA-doped PBI membranes between the cathodes and the anodes under a similar procedure.

4.2 PBI-Based MEAs Operated in WO₃—O₂ Supercapacitor Mode and Fuel Cell Mode

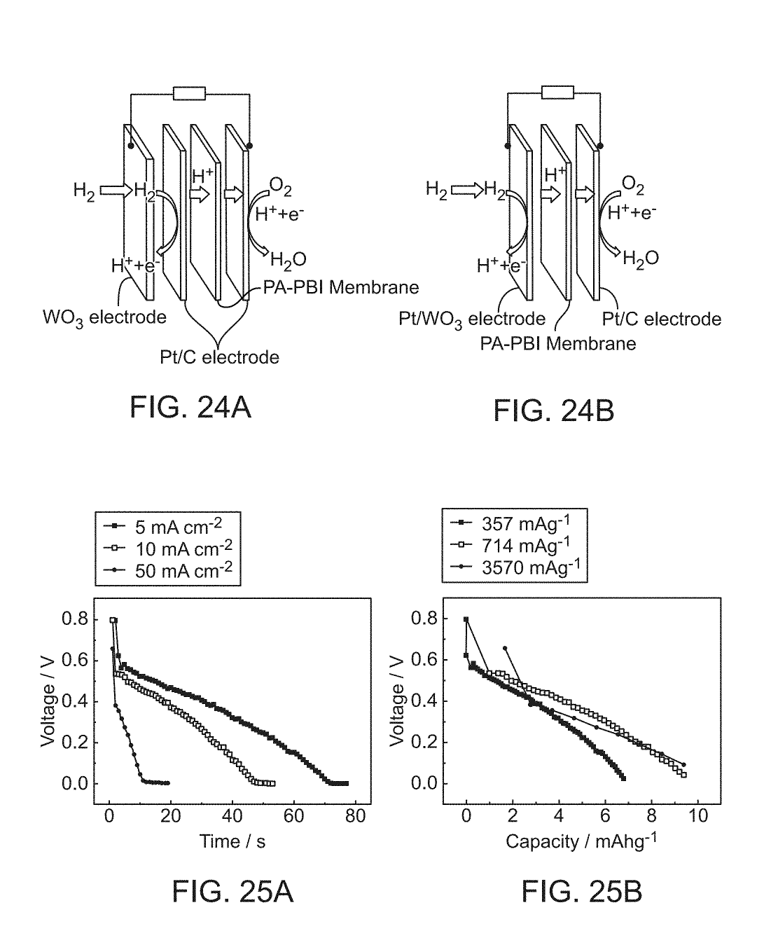

Two configurations of PEMFC based on WO₃ electrode and PBI electrolyte are proposed (See FIG. 24). The first configuration (a) is similar as that of perfluorosulfonic acid-based PEMFCs, where a layer of WO₃ electrode is fabricated adjacent to a Pt/C anode catalyst layer. The second configuration (b) directly uses a Pt/WO₃ layer as an anode, without including an adjacent Pt/C layer. The configuration (b) is based on the outstanding conductivity of the WO₃ electrode in the presence of hydrogen. By incorporating WO₃ directly into the anode, it is expected to bring the following advantages: (i) WO₃ can be charged with the aid of platinum under H₂ atmosphere at an elevated temperature; and (ii) WO₃ can serve as a co-catalyst reducing the amount of Pt used.

Such configurations allow the devices to operate in WO₃—O₂ supercapacitor or fuel cell mode. For example, the cells can be operated as WO₃—O₂ supercapacitor mode using charged WO₃ as the active anode and oxygen as the active oxidant in the cathode. By supplying the anodes and the cathodes with H₂ and O₂, respectively, the cells can be operated in the fuel cell mode. Particularly, by interrupting the H₂ supply, the fuel cells can be tested in the H₂ starvation mode.

Devices with the configuration (a) were assembled and tested under the above mentioned three modes. FIG. 25a shows the corresponding galvanostatic discharging curves at current density of about 5 mA cm⁻² to about 50 mA cm⁻². The voltage decreases almost linearly with the discharging time, which is consistent with the capacitive behavior of the WO₃ anode. The capacities of the anode at different current densities are plotted in FIG. 25b. The anode delivers a capacity of about 7 to about 10 mAh g¹ at current densities from about 5 mA cm⁻² (about 357 mA g¹) to about 50 mA cm⁻² (about 3570 mA g¹), which is lower than observed in perfluorosulfonic acid-based devices (about 40 mAh g¹).

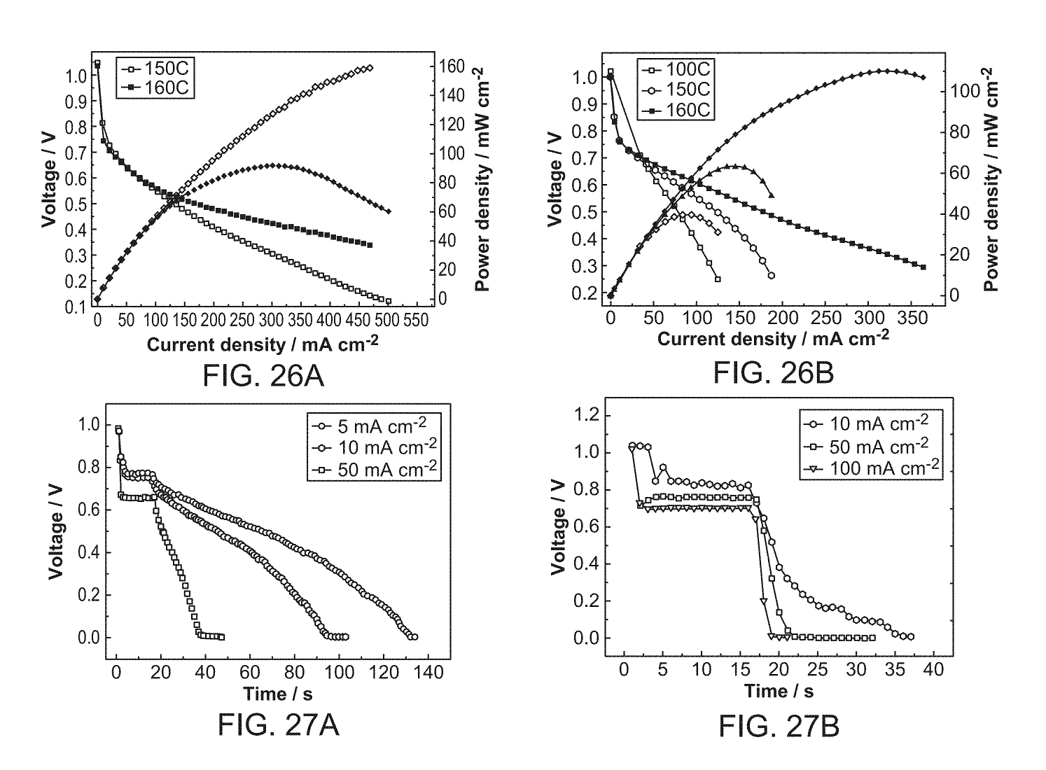

FIG. 26 shows the polarization curves of the WO₃-based PEMFC operated in the fuel cell mode and its comparison with a control MEA (control cell formed without WO₃) at different temperatures. The control cell shows improved performance with increasing temperature. The WO₃-based cell also exhibits improved performance with increasing temperature. However, the peak power density is lower than that of the control cell (about 100 mW cm⁻² vs. about 160 mW cm⁻²). More significant polarization loss is observed with high discharging current density. Similar results were observed in perfluorosulfonic acid-based WO₃ PEMFCs, which is due to increased mass transfer resistance. Nevertheless, the results demonstrate the feasibility of forming PBI-based intermediate temperature fuel cells by incorporating WO₃ as an energy storage material.

To test the response of the MEAs under fuel starvation, flow of H₂ was switched to N₂ and the fuel cell mode was switched to the WO₃—O₂ supercapacitor mode. FIG. 27 shows the voltage profiles vs. time under different discharging current densities for MEAs with and without WO₃. Both of the cells exhibit voltage decays with discharging time. Compared with the MEA with WO₃ layer, the discharging time is much longer than those without the WO₃ layer (e.g., about 95 s vs. about 35 s at about 10 mA cm⁻² or about 40 s vs. about 20 s at about 50 mA cm⁻²), demonstrating the energy storage capability of the WO₃ layer.

The above results demonstrate the feasibility of using WO₃ as an energy storage material in low temperature and intermediate temperature PEMFCs. By incorporating a WO₃ electrode, a PEMFC is endowed with dynamic response to transient load and fuel interruption. Embodiments can be extended to the high temperature PEMFCs based on other membranes, SAFCs and SOFCs.

Integration of a WO₃ electrode inside a fuel cell system can improve the stability in responding to varying power loads and fuel supply fluctuations. An integrated WO₃—O₂ supercapacitor inside a fuel cell can provide the high power demand for a motor when a fuel cell vehicle is starting up or accelerating. Therefore, a secondary system such as batteries or capacitors can be omitted. A control system of electric vehicles can be rendered less complex with an all-in-one power supply compared with a hybrid system. This strategy also permits a reduction in size and cost of a power system. Although some embodiments are explained in the context of automobiles, embodiments are not confined to automotive applications, and other embodiments can provide a solution to attain low-cost, reliable distributed power generation. The WO₃ electrode can function as a backup power supply in such a system to ensure its stability.

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be “substantially” or “about” the same as a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

What is claimed is:

1. A fuel cell comprising:
an anode;
a cathode; and
an ion conducting membrane disposed between the anode and the cathode,
wherein the anode includes a tungsten oxide-containing layer.

2. The fuel cell of claim 1, wherein the tungsten oxide-containing layer includes tungsten trioxide.

3. The fuel cell of claim 2, wherein the tungsten trioxide has a hexagonal crystalline structure.

4. The fuel cell of claim 2, wherein a loading of the tungsten trioxide in the anode is in a range of 0.5 mg cm⁻² to 30 mg cm⁻².

5. The fuel cell of claim 2, wherein a loading of the tungsten trioxide in the anode is in a range of 0.5 mg cm⁻² to 10 mg cm⁻².

6. The fuel cell of claim 2, wherein the tungsten trioxide is in the form of nanostructures.

7. The fuel cell of claim 6, wherein the nanostructures have aspect ratios greater than 3.

8. The fuel cell of claim 2, wherein the tungsten oxide-containing layer includes a composite including a carbonaceous material and the tungsten trioxide dispersed with the carbonaceous material.

9. The fuel cell of claim 8, wherein a weight percentage of the tungsten trioxide in the composite is in a range of 10% to 99%.

10. The fuel cell of claim 8, wherein a weight percentage of the tungsten trioxide in the composite is in a range of 50% to 99%.

11. The fuel cell of claim 1, wherein the anode further includes an anode catalyst layer adjacent to the tungsten oxide-containing layer.

12. The fuel cell of claim 11, wherein the anode further includes an anode gas diffusion layer adjacent to the tungsten oxide-containing layer.

13. The fuel cell of claim 1, wherein the cathode includes a cathode catalyst layer.

14. The fuel cell of claim 13, wherein the cathode further includes a cathode gas diffusion layer adjacent to the cathode catalyst layer.

15. The fuel cell of claim 1, wherein the ion conducting membrane is a proton exchange membrane.

16. The fuel cell of claim 15, wherein the proton exchange membrane is an acidic proton exchange membrane.
